(19) United States
(12) Patent Application Publication
(10) Pub. No.: US 2004/0257034 A1
(43) Pub. Date: Dec. 23, 2004

(54) Rechargeable battery pack and housing

(75) Inventors: Ali Moayer, Castro Valley, CA (US); Bryed Billerbeck, Mountain View, CA (US); Howard Miyamura, Newark, CA (US); Maurice Alou, Menlo Park, CA (US); Jean-Michel Chardon, Livermore, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 10/602,493

(22) Filed: Jun. 23, 2003

(51) Int. Cl. H02J 7/00

(52) U.S. Cl. 320/107

(57) ABSTRACT

A system and method for providing a rechargeable battery system which includes a battery compartment which can accommodate either one or more non-rechargeable batteries or a rechargeable battery pack, and a rechargeable battery pack which includes recharge electronics and a detection module. The detection module detects when the rechargeable battery pack is inserted. This ensures that non-rechargeable batteries are not accidentally charged. A recharge circuit for recharging the rechargeable batteries is included. A metering module for metering the charge in the rechargeable batteries is also included in the rechargeable battery pack. The battery compartment and rechargeable provide the user with the ability to power the device from rechargeable batteries, non-rechargeable batteries, host bus or AC power, and the ability to recharge the rechargeable batteries from either the host bus or AC power.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

1. Field of the Invention

This invention relates generally to battery packs, and more specifically to rechargeable battery cartridges and housing.

2. Description of the Related Art

In recent years, the use of power-consuming devices has increased tremendously. Amongst many others, such devices include digital cameras, cell phones, Personal Digital Assistants (PDAs), keyboards, mice, gaming devices, etc. In addition, an increasing emphasis is being placed on the portability of many of these devices. Portability implies that these devices cannot be continuously connected to an electrical outlet to obtain the required power. Thus such devices often need to use batteries to provide them with power.

Disposable or non-rechargeable batteries (such as AA, AAA, C, D, etc.) can be, and often are, used to provide power to such devices. However, there are several disadvantages to such non-rechargeable batteries. Depending on the device power requirements, they may require frequent replacement which can be very expensive and bad for the environment. Further, some countries try to discourage the use of conventional batteries by charging exorbitant taxes upon import of such devices.

Thus rechargeable batteries (such as Nickel Metal Hydride, Lithium Ion, Nickel Cadmium, Lithium Polymer, etc.) are now being used for such devices. However, there are also several disadvantages associated with these conventional rechargeable batteries. Some of these disadvantages are discussed below.

When conventional rechargeable batteries get fully discharged, they need to be recharged. Such recharging could take several hours, which can be extremely inconvenient. For instance, if one is in the middle of a photo session when the rechargeable batteries get discharged, the situation may be quite problematic unless one has an expensive spare rechargeable battery pack.

Further, rechargeable batteries can only be recharged a finite number of times (on the order of 300). Again, this may require the user to keep and/or buy as needed, expensive spare rechargeable battery packs.

Some of the issues described above with respect to non-rechargeable and rechargeable batteries could be resolved by providing the user with the ability to use either rechargeable or non-rechargeable batteries in a device. Doing so allows the user to use rechargeable batteries on a regular basis, but to use non-rechargeable batteries while his rechargeable batteries are being recharged or if they die during a photo session away from recharge capability, etc. Moreover, it allows manufactures to create and sell different Stock Keeping Units (SKUs) for different regions more conveniently. For example, if Germany does not allow non-rechargeable batteries, the German camera version can ship with the rechargeable battery pack. If customers in another country are more concerned about cost at point of purchase, non-rechargeable batteries can be shipped at significantly lower cost and hence lower retail price with minimum complication. The customer could then use his own rechargeable batteries in conjunction with an external recharger if desired.

However, there are several concerns with permitting users to use either non-rechargeable or rechargeable batteries in a device. Conventionally, most non-rechargeable batteries are purposely manufactured to be a different size and/or form factor than rechargeable batteries. This is to avoid the danger of accidental recharge of non-rechargeable batteries. Recharging of non-rechargeable batteries could cause them to explode, flame, or fume. It could also cause catastrophic device failures.

Some attempts have been made in the prior art to overcome some of the above problems.

U.S. Pat. No. 5,475,626 discusses the use of rechargeable and non-rechargeable batteries in a personal computer. However, the detection circuitry and the recharging circuitry are part of the device (or its peripherals) rather than of the rechargeable battery pack. Thus the device has to be burdened with the cost of the rechargeable battery detection, recharge circuitry, etc., regardless of whether or not rechargeable batteries are actually used. Moreover, the patent discloses use of battery pack terminals as conductors for the battery packs, rather than using the actual positive and negative electrodes of the individual batteries themselves. Thus extra contacts/mechanical parts need to be added. The cost and size of the product is thus increased.

U.S. Pat. No. 5,661,392 also proposes a solution for interchangeably using rechargeable and non-rechargeable batteries in a device. However, as above, the recharge circuitry is part of the device (or its peripherals) rather than of the rechargeable battery pack, and separate rechargeable pack electrodes (different from the individual battery electrodes) are used. In addition, non-rechargeable batteries are also used in the form of a non-rechargeable battery pack, so the user does not have the option of using off-the-shelf non-rechargeable batteries.

U.S. Pat. No. 6,014,009 discusses the interchangeable use of non-rechargeable and rechargeable batteries in a device. A battery compartment using flexible fingers (springs) is disclosed, which can accommodate either a rechargeable battery or non-rechargeable batteries, where the rechargeable battery and the non-rechargeable batteries have significantly different sizes/thicknesses. Mechanical breakages of the springs, resulting in inaccurate contacts may result. Further, the recharging circuitry is included in the device rather than in a rechargeable battery pack.

U.S. Pat. No. 6,505,952 discusses the use of non-rechargeable and rechargeable batteries specifically in a flashlight, but suffers from similar limitations. Once again, the rechargeable battery pack electrodes are not the individual battery electrodes. Further, the recharge circuitry is in the device, and not in the rechargeable battery pack. Moreover, there is no detection scheme to detect when the rechargeable battery pack or the non-rechargeable batteries are used, since different contacts are used in these cases, and the non-rechargeable batteries are mechanically isolated from the recharge circuitry in the device.

Thus what is needed is a hybrid battery compartment with a form factor that accepts either conventional non-rechargeable batteries or a rechargeable battery pack, and a rechargeable battery pack that fits in the hybrid battery compartment. In addition, what is needed is some intelligence to detect when a rechargeable battery pack is used, and when non-rechargeable batteries are used, so that a user cannot accidentally recharge non-rechargeable batteries which could result in device damage. Further, what is needed is a rechargeable battery pack which contains a recharging circuit, and which uses the electrodes of the rechargeable batteries.

### BRIEF SUMMARY OF THE INVENTION

The present invention is a system and method for providing a hybrid battery compartment with a form factor that accepts either conventional non-rechargeable batteries or a rechargeable battery pack, and a rechargeable battery pack that fits in the hybrid battery cavity. The rechargeable battery pack includes recharge electronics as well as intelligence for determining when the rechargeable battery is inserted in the hybrid battery cavity. Moreover, in one embodiment, the electrodes of the rechargeable batteries are used, rather than adding separate electrical contacts for the rechargeable battery pack. In addition, in accordance with an embodiment of the present invention, the rechargeable battery pack and the battery compartment provide the user with the ability to power the device from rechargeable batteries, non-rechargeable batteries, host bus or AC power, as well as the ability to recharge the rechargeable batteries from either host bus or AC power.

The battery compartment in accordance with the present invention can hold one or more standard non-rechargeable batteries while it provides enough room for rechargeable battery packs. Thus a rechargeable battery system in accordance with an embodiment of the present invention will allow users to utilize either disposable batteries or rechargeable cartridges. The cartridge designs can support various battery technologies (such as Nickel Cadmium, Lithium Polymer, Lithium Ion, etc.) and they include recharge electronics and metering capability. One aspect of the present invention is that a rechargeable battery pack in accordance with the present invention allows system designers to provide a universal battery compartment for various battery technologies without the need for external adapters.

In one embodiment, the rechargeable battery pack is self-contained in that it includes rechargeable batteries, recharge electronics and metering electronics. In addition, a system in accordance with an embodiment of the present invention includes intelligence to detect when a rechargeable battery pack is used, and when disposable batteries are used. Such a combination of rechargeable battery pack and battery compartment allows for easy detection, identification, and metering of rechargeable batteries in mobile systems.

The features and advantages described in this summary and the following detailed description are not all-inclusive, and particularly, many additional features and advantages will be apparent to one of ordinary skill in the art in view of the drawings, specification, and claims hereof Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1A illustrates a device with non-rechargeable batteries.

FIG. 1B illustrates a device with a rechargeable battery pack, in accordance with an embodiment of the present invention.

FIG. 2 is a block diagram illustrating some of the components of a rechargeable battery system in accordance with an embodiment of the present invention.

FIG. 3A is a top view of a rechargeable battery pack in accordance with one embodiment of the present invention.

FIG. 3B is a bottom view of a rechargeable battery pack in accordance with one embodiment of the present invention.

FIG. 3C is a side view of a rechargeable battery pack in accordance with one embodiment of the present invention.

FIG. 3D is another side view of a rechargeable battery pack in accordance with one embodiment of the present invention.

FIG. 4 is an exploded view of the various components of a rechargeable battery pack and a portion of the battery compartment in accordance with an embodiment of the present invention.

FIG. 5A is a circuit diagram depicting a device when a rechargeable battery pack is used in accordance with an embodiment of the present invention.

FIG. 5B is a circuit diagram depicting a device when non-rechargeable batteries are used in accordance with an embodiment of the present invention.

### DETAILED DESCRIPTION OF THE INVENTION

The figures depict a preferred embodiment of the present invention for purposes of illustration only. It is noted that similar or like reference numbers in the figures may indicate similar or like functionality. One of skill in the art will readily recognize from the following discussion that alternative embodiments of the structures and methods disclosed herein may be employed without departing from the principles of the invention(s) herein. It is to be noted that the term “battery pack” is sometimes used interchangeably with the term “cartridge”.

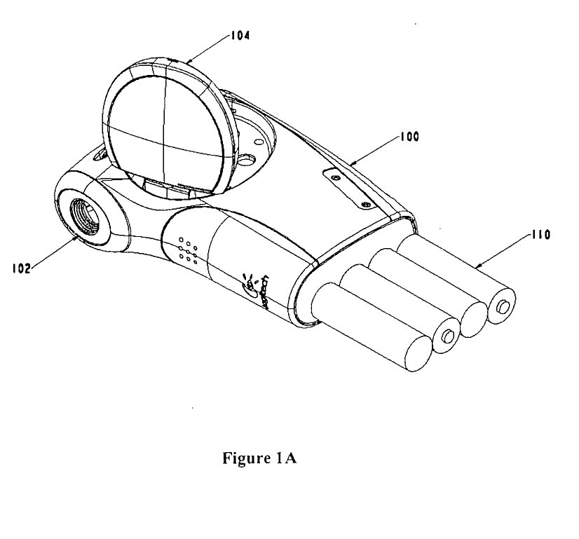

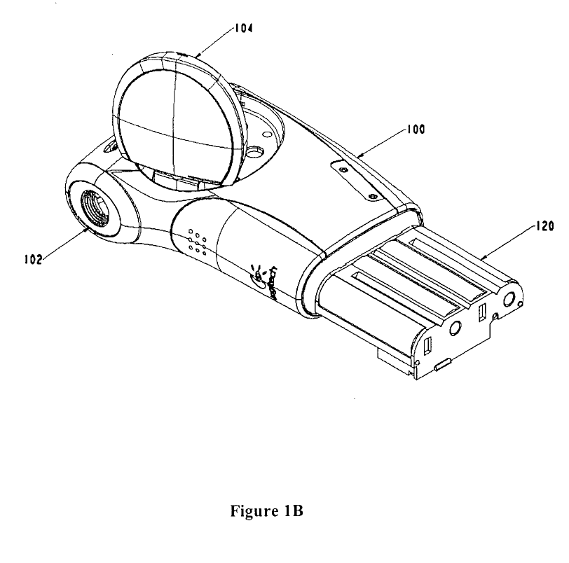

FIG. 1A illustrates a portable device with non-rechargeable batteries. The portable device 100 is powered using four non-rechargeable batteries 110 (e.g., AA).

In FIG. 1A, the device 100 is a camera. The lens 102 and the Liquid Crystal Display (LCD) 104 are visible in FIG. 1A. However, it will be apparent to one of ordinary skill in the art that the device 100 can be any device which requires the use of batteries. For instance, the device 100 can be any other portable device, such as a tape recorder, a camcorder, a cell phone, a Personal Digital Assistant (PDA), a laptop computer, etc.

Since these batteries 110 are non-rechargeable, once they are drained, the batteries 110 need to be disposed of, and conventionally, be replaced with new non-rechargeable batteries 110. Such repeated replacement of batteries can prove to be expensive over time.

FIG. 1B illustrates a device 100 with a rechargeable battery pack 120, in accordance with an embodiment of the present invention. As an alternative to replacing the non-rechargeable batteries 110 above with other non-rechargeable batteries 110, in accordance with an embodiment of the present invention, the non-rechargeable batteries 110 can be replaced with rechargeable battery pack 120.

In FIG. 1B, a single rechargeable battery pack 120 replaces four standard form non-rechargeable batteries 110. It will be obvious to one of ordinary skill in the art that in accordance with various embodiments of the present invention, a single rechargeable battery pack 120 can serve as a replacement for various numbers of standard form non-rechargeable batteries 110. For instance, a single rechargeable battery pack 120 can have the form factor of one single non-rechargeable battery, or of two, or four non-rechargeable batteries, etc. Additionally, in accordance with various embodiments of the present invention, the non-rechargeable batteries 110 which can be replaced by the rechargeable battery pack 120 can be of various standard form factors, such as AA, AAA, C, D, etc.

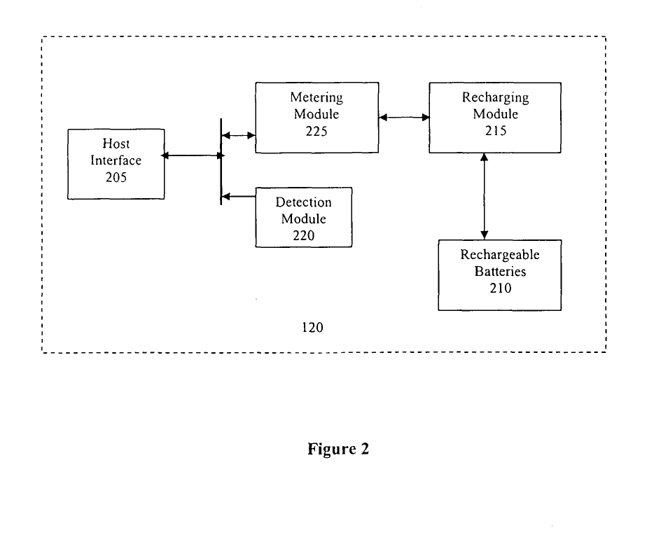

FIG. 2 is a block diagram illustrating some of the components of a rechargeable battery pack 120 in accordance with an embodiment of the present invention. In one embodiment, the components of a rechargeable battery pack 120 include a host interface 205, rechargeable batteries 210, a recharging module 215, a detection module 220, and a metering module 225.

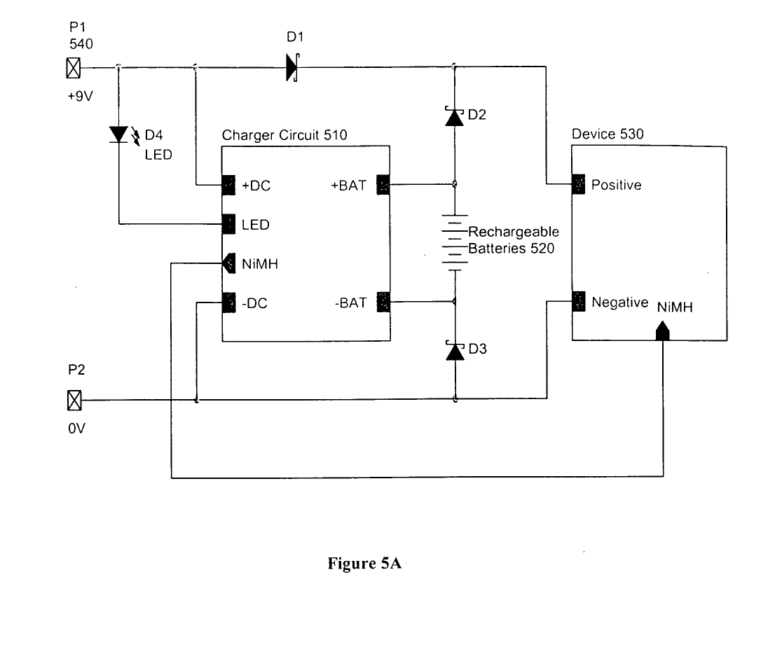

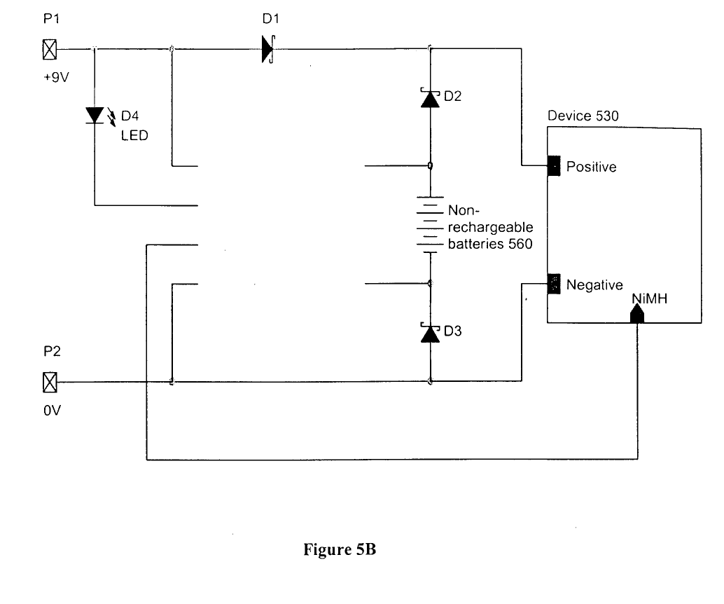

The host interface 205 is an interface to the portable device 100. As mentioned above, the rechargeable batteries 210 can vary in number (e.g., 1,2,3,4, etc.) and in type (e.g., NiMH, etc.). The recharging module 215 recharges the rechargeable batteries 210, and comprises, in one embodiment, of standard recharge technologies known in the art. The charger circuit 510 in FIG. 5A one way in which recharging module 215 could be implemented. By including the recharging module 215 within the battery pack 120, the cost of the rechargeable battery system is contained within the rechargeable battery pack 120.

The detection module 220 detects when the rechargeable battery pack inserted into the device 100, and communicates that information to the portable device 100 via the host interface 205. (In one embodiment, non-rechargeable batteries being inserted into the device is defined as the default.) This prevents accidental “charging” of non-rechargeable batteries. It is to be noted that the rechargeable battery pack 120 can be detected/identified mechanically and/or electronically, or in any other way (e.g., magnetically). One embodiment of the detection mechanism is discussed in further detail with respect to FIG. 5A.

In one embodiment, the metering module 225 tracks and remembers the amount of battery power stored in the rechargeable battery pack independent of the hosting system (i.e. device). An accurate meter needs to keep track of how much charge flows into the battery as well as how much charge is taken out. Such an in-built metering system in the rechargeable battery pack allows for accurate metering of the charge, regardless of whether the battery is in the device or outside the device (e.g., for external charging). This is unlike conventional systems where the metering is done in the device itself, and thus the charge in the battery cannot be metered when the battery is out of the device. The integration of the metering module 225 into the battery pack 120 in accordance with an embodiment of the present invention makes the meter accurate and mobile. Further, the metering module 225 in the rechargeable battery pack 120 can track and remember the amount of battery power stored in the cartridge independent of the hosting system.

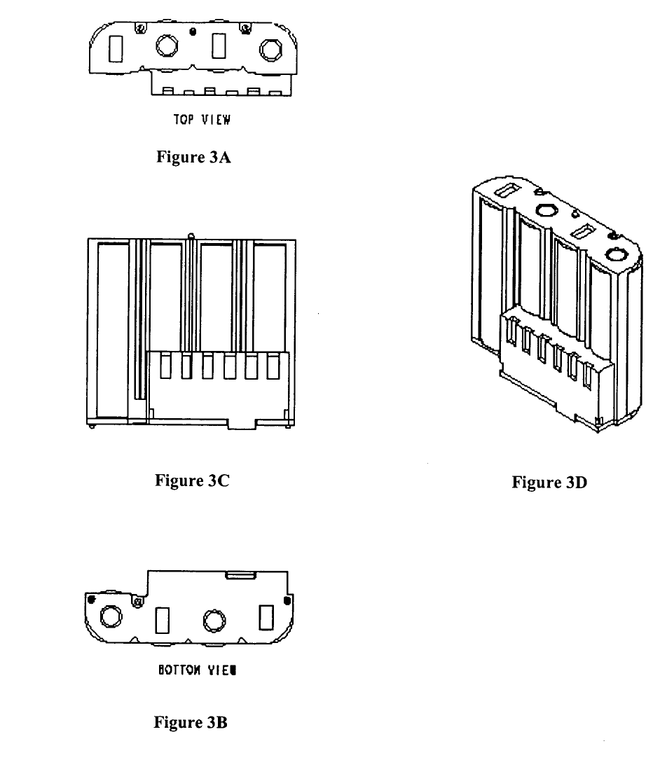

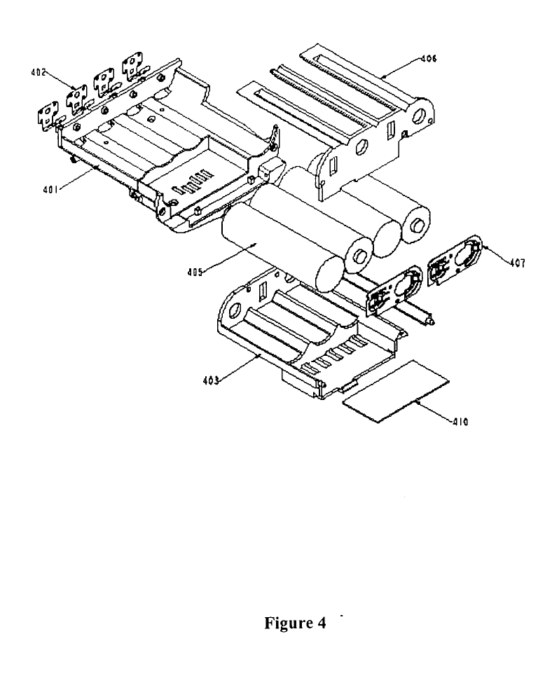

FIG. 3A is a top view of a rechargeable battery pack 120 in accordance with one embodiment of the present invention, as well as some of the host system (i.e. portable device 100) interface electrical contacts. FIG. 3B is a bottom view of a rechargeable battery pack 120 in accordance with one embodiment of the present invention, as well as the remaining electrical contacts for the host system interface. FIGS. 3C & 3D are side views of a rechargeable battery pack 120 in accordance with an embodiment of the present invention. FIG. 4 shows these various components in some detail.

FIG. 4 is an exploded view of the various components of the rechargeable battery pack 120 as well as part of a battery compartment (in the portable device 100) in which the rechargeable battery pack 120 can be placed, in accordance with an embodiment of the present invention.

A rechargeable battery pack 120 is placed in a battery compartment of the portable device 100. The bottom half of the battery compartment 401 can be seen in FIG. 4. (The top half of the battery compartment is not shown in the Figure). It can be seen that battery contacts 402 are present on the bottom half of the battery compartment 401. (In some embodiments, similar battery contacts are present on the top half of the battery compartment as well.) These battery contacts 402 establish contact between the battery cartridge 401 and the rechargeable batteries 405. Battery contacts 407 in the battery compartment door can also be seen in FIG. 4. It will be obvious to one skilled in the art that the actual placement of the battery contacts can be varied. For instance, the battery contacts may be placed on the top half of the battery compartment (not shown in FIG. 4).

The rechargeable battery pack 120 includes a bottom half of the battery cartridge 403 and a top half of a battery cartridge 406. The rechargeable batteries 405 themselves are encased between the top half 406 and the bottom half 403 of the battery cartridge. In the embodiment depicted in FIG. 4, there are four rechargeable batteries 405 in this pack. It is to be noted that the actual number of rechargeable batteries in a pack can vary. As mentioned above, recharging circuit electronics 410 are also part of the battery pack shown in FIG. 4.

As mentioned above, in one embodiment of the present invention, the device 100 can be powered by using non-rechargeable batteries 120, or rechargeable batteries 110. In addition, the device 100 can, in one embodiment, also be powered by using an external power source. FIG. 5A is a schematic which illustrates a system in accordance with the present invention, with the rechargeable battery pack 120 inserted. The simplified schematic in FIG. 5A shows a charger circuit 510, rechargeable batteries 520, a device 530, and power source 540. It is to be noted that the charger circuit 510 and the rechargeable batteries 520 are part of a rechargeable battery pack 120 in accordance with the present invention.

It can be seen from FIG. 5A that several pads for connections are included in the charger circuit 510 in one embodiment. The “+DC” pad establishes a connection with the positive terminal of the power source 540. The “−DC” pad establishes a connection with the negative terminal of the power source 540. The “+Bat” pad establishes a connection with the positive terminal of the rechargeable batteries 520. The “−Bat” pad establishes a connection with the negative terminal of the rechargeable batteries 520. In one embodiment, when inserting the charger circuit 510, −DC and −BAT must make contact first.

In one embodiment, the charger circuit 510 includes a pad labeled “LED” (Light Emitting Diode), which is used to let the user know if the rechargeable batteries 520 are charging or charged. This pad is connected to LED D4. In one embodiment, the LED pad drives an open-drain NPN transistor, and there is no risk of injecting current into the device.

In one embodiment, the charger circuit 510 includes a pad labeled “NiMH” which is used to indicate when the rechargeable batteries 520 are inserted. This NiMH pad helps detect when the rechargeable battery pack is inserted into the device. This is described in more detail below.

The rechargeable batteries 520 can be, for example, Nickel Metal Hydride (NiMH) batteries. In FIG. 5A, four rechargeable batteries are part of the battery pack 120. However, it is to be noted that the type of rechargeable battery used, or the number of rechargeable batteries used in a pack, may vary.

As mentioned above, the device 530 can be any device needing batteries, such as a camera, a PDA, a cell phone, etc. As can be seen from FIG. 5A, device 530 also has several pads. The pad labeled “Positive” establishes contact with the positive terminal of the battery 520, as well as with the positive terminal of the power source 540 (when the device 530 is connected to the power source 540). The pad labeled “Negative” establishes contact with the negative terminal of the battery 520, as well as with the negative terminal of the power source 540 (when the device 530 is connected to the power source 540).

In addition, the pad labeled “NiMH” in the device 530 establishes contact with the like-labeled pad on the circuit charger 510. This pad (along with the NiMH pad on the circuit charger 510) is used to detect when a rechargeable battery pack 120 is inserted into the device 100. When a connection is established between the NiMH pads on the device and in the rechargeable battery pack 120 (which, in one embodiment are on the circuit charger 510), this signals the device 530 about the presence and type of a rechargeable battery cartridge. When no such interconnection occurs, it is assumed that a non-rechargeable battery is present. It is to be noted that in one embodiment, any type of connector pads may establish contact to detect the presence of a rechargeable battery pack 120.

In the embodiment of FIG. 5A, the external power source 540 is a +9V DC source. It will be apparent to one of ordinary skill in the art that the actual voltage of the source will depend upon the power required by the device 530, and may be higher or lower than 9V.

Let us now discuss how the schematic illustrated in FIG. 5A works. When the device 530 is not connected to the external power source 540, it is powered by the rechargeable batteries 520 through diodes D2 and D3. When the device 530 is connected to the external power source 540, the external power source 540 provides power to both the rechargeable batteries 520 in the device 530, as well as the device 530. The external power source 540 provides power to charge the rechargeable batteries 520 through the charger circuit 510, and to operate the device 530 through diode D1. When the external power source 540 is disconnected, the rechargeable batteries 520 provide power to the device 530. It is to be noted that, in one embodiment, the device could be powered, and the rechargeable batteries could be charged, through an AC source (using an AC-to-DC converter), or through the host bus for the device.

In one embodiment, the diode D1 prevents the rechargeable batteries 520 from being drained by the charger circuit 510 or by an inoperative power source 540. The diode D2 prevents charging the batteries 520 directly from the +9V DC source 540. The diode D3 is to decouple the battery charging return current and the device return current when the +9V DC source is connected. Failing to decouple both return currents will affect the charging process of NiMH batteries. Further, in one embodiment, a (Metal Oxide Semiconductor) MOS transistor can be put in parallel to D3 to avoid the voltage drop when the DC source 540 is not connected.

FIG. 5B is a schematic of an embodiment of the present invention, where the device 530 is used with non-rechargeable batteries 560. The various components and functioning of FIG. 5B are very similar to that of FIG. 5A, with some differences which are discussed below.

Since non-rechargeable batteries 560 are being used, the charger circuit 510 is not present in FIG. 5B. Further, in FIG. 5B, the external power source 540 provides power only to the device 530. In FIG. 5B, since the batteries being used are non-rechargeable 560, the external power source 540 does not provide any power to the non-rechargeable batteries 560. When the DC source 540 is disconnected, the non-rechargeable batteries 560 provide power to the device.

While particular embodiments and applications of the present invention have been illustrated and described, it is to be understood that the invention is not limited to the precise construction and components disclosed herein and that various modifications, changes, and variations which will be apparent to those skilled in the art may be made in the arrangement, operation and details of the method and apparatus of the present invention disclosed herein, without departing from the spirit and scope of the invention as defined in the following claims.

What is claimed is:

1. A battery system for providing power to a device, comprising:
a battery compartment which can accommodate at least one rechargeable battery pack interchangeably with at-least one non-rechargeable battery; and
a rechargeable battery pack including:
at least one rechargeable battery;
a recharging module coupled to the rechargeable battery for charging the at least one rechargeable battery;
a detection module in communication with the device to detect when the rechargeable battery pack is inserted into the battery compartment.

2. The battery system of claim 1, wherein the rechargeable battery pack further comprises:
a metering module for tracking the amount of battery power in the at least one rechargeable battery.

3. The battery system of claim 1, wherein the device is coupled to an external power supply to charge the at least one rechargeable battery through the recharging module.

4. The battery system of claim 3, wherein the external power supply is provided by an AC source.

5. The battery system of claim 3, wherein the external power supply is provided by a host bus of the device.

6. The battery system of claim 3, wherein the at least one rechargeable battery provides power to the device only when the device is not coupled to the external power supply.

7. The battery system of claim 1, wherein the detection module comprises at least one connector pad which makes contact with a corresponding at least one connector pad in the battery compartment, and wherein contact between the at least one connector pad and the corresponding at least one connector pad indicates that the rechargeable battery pack has been inserted into the device.

8. The battery system of claim 1, wherein the battery compartment comprises:
a first battery contact pad for establishing contact with a first terminal of either the at least one rechargeable battery or the at least one non-rechargeable battery;
a second battery contact pad for establishing contact with a second terminal of either the at least one rechargeable battery or the at least one non-rechargeable battery;
a detection contact pad for establishing contact with a detection contact pad on the rechargeable battery pack, wherein such contact indicates that a rechargeable battery pack has been inserted into the battery compartment.

9. The battery system of claim 1, wherein the device is a camera.

10. A battery compartment for accommodating at least one rechargeable battery pack interchangeably with at least one non-rechargeable battery, the at least one rechargeable battery pack including at least one rechargeable battery, the battery compartment comprising:
a first battery contact pad for establishing contact with a first terminal of either the at least one rechargeable battery or the at least one non-rechargeable battery;
a second battery contact pad for establishing contact with a second terminal of either the at least one rechargeable battery or the at least one non-rechargeable battery;
a detection contact pad for establishing contact with a detection contact pad on the rechargeable battery pack, wherein such contact indicates that a rechargeable battery pack has been inserted into the battery compartment.

11. A rechargeable battery pack for providing power to a device, wherein the rechargeable battery pack can be used in the device interchangeably with the at least one non-rechargeable battery, the rechargeable battery pack comprising:
at least one rechargeable battery;
a recharging module coupled to the rechargeable battery for charging the at least one rechargeable battery;
a detection module in communication with the device to detect when the rechargeable battery pack is inserted into the device.

12. The rechargeable battery pack of claim 11, further comprising a metering module for tracking the amount of battery power in the at least one rechargeable battery.

13. The rechargeable battery pack of claim 11, wherein the device is coupled to an external power supply to charge the at least one rechargeable battery through the recharging module.

14. The rechargeable battery pack of claim 13, wherein the external power supply is provided by an AC source.

15. The rechargeable battery pack of claim 13, wherein the external power supply is provided by a host bus of the device.

16. The rechargeable battery pack of claim 13, wherein the at least one rechargeable battery provides power to the device only when the device is not coupled to the external power supply.

17. The rechargeable battery pack of claim 11, wherein the detection module comprises at least one connector pad which makes contact with a corresponding at least one connector pad in a battery compartment in the device, and wherein contact between the at least one connector pad and the corresponding at least one connector pad indicates that the rechargeable battery pack has been inserted into the device.

18. The rechargeable battery pack of claim 11, wherein the device is a camera.

19. A method of using at least one rechargeable battery pack interchangeably with at least one non-rechargeable battery to provide power to a device, the method comprising:
providing a battery compartment in the device which can accommodate the rechargeable battery pack interchangeably with the at least one non-rechargeable battery; and
detecting when the rechargeable battery pack is inserted into the battery compartment.

20. The method of claim 19, wherein the rechargeable battery pack includes at least one rechargeable battery.

21. The method of claim 20, further comprising:
charging the at least one rechargeable battery when the device is connected to an external power source.

22. The method of claim 21, wherein the external power source is provided by an AC source.

23. The method of claim 21, wherein the external power source is provided by a host bus of the device.

24. The method of claim 19, further comprising:
metering the battery power in the at least one rechargeable battery.
